(19) United States
(12) Patent Application Publication
(10) Pub. No.: US 2003/0038895 A1
(43) Pub. Date: Feb. 27, 2003

(54) System and method for providing program status information

(76) Inventors: Hong Yang, San Diego, CA (US); Jenny Su Chow, San Diego, CA (US)

Correspondence Address: FITCH EVEN TABIN AND FLANNERY, 120 SOUTH LA SALLE STREET, SUITE 1600, CHICAGO, IL, 60603-3406, US

(21) Appl. No.: 09/935,451

(22) Filed: Aug. 22, 2001

(51) Int. Cl. H04N 5/50; H04N 5/44

(52) U.S. Cl. 348/569; 348/734

(57) ABSTRACT

The present invention relates to an entertainment system and method for displaying information on a display device in the entertainment system. The method comprises selecting a key corresponding to a broadcast channel, displaying a show associated with the channel, and simultaneously displaying a status of the show for a predetermined period of time.

### BACKGROUND OF THE INVENTION

1. Field of the Invention

The present invention relates generally to the presentation of channel, program, and broadcast information for a display system such as a television broadcast system. More particularly, the present invention relates to a system and method for providing program status information in a broadcast system.

2. Description of Art Related to the Invention

In recent years, there has been a increasing demand for entertainment systems working in conjunction with various types of broadcasting systems, including systems that broadcast on the airwaves, through cable and via satellite. Along with this demand is a corresponding increase in the number of stations accessible. To select a program to view, many viewers simply “channel surf” until they find a channel with a desirable program. Channel surfing refers to the process of sequentially viewing each channel.

However, during such channel surfing, it is difficult for the viewer to determine what program he is currently viewing, when the program started and/or will end, or how much time there is remaining on the program. Currently, in order to obtain information regarding the title, start and end times of a program, the user typically has to select the “display” key on the remote control to activate a viewing screen which displays the current channel information. Alternatively, the user has to select viewing of an electronic programming guide by navigating through the main menu and subsequent menus, to view current program information. Such techniques for viewing programming information are cumbersome and time-consuming.

### BRIEF SUMMARY OF THE INVENTION

The present invention relates to an entertainment system and method for displaying information on a display device in the entertainment system. The method comprises selecting a key corresponding to a broadcast channel, displaying a show associated with the channel, and simultaneously displaying a status of the show for a predetermined period of time. Various embodiments are described.

### BRIEF DESCRIPTION OF THE DRAWINGS

FIG. 1A is an illustrative embodiment of an entertainment system utilizing the present invention.

FIG. 1B is an illustrative embodiment of the remote controller 115 of FIG. 1A.

FIG. 2A illustrates one embodiment of a view screen with a Main menu 200 provided in accordance with the principles of the invention.

FIG. 2B illustrates one embodiment of a view screen with the Reference menu 210₃ provided in accordance with the principles of the invention.

FIG. 2C illustrates one embodiment of a window superimposed over the Reference menu 210₃ provided in accordance with the principles of the invention.

FIG. 2D illustrates one embodiment of a view screen with the Status Bar menu 252, provided in accordance with the principles of the invention.

FIG. 2E illustrates one embodiment of the Status Bar Set-Up menu 260, provided in accordance with the principles of the invention.

FIG. 2F illustrates one embodiment of the Status Bar Set-Up menu 260 upon selection of the Status Bar Display Interval key 270e, provided in accordance with the principles of the invention.

FIG. 2G illustrates one embodiment of the Status Bar Set-Up menu 260 upon selection of the Remote Control Activity key 270f, provided in accordance with the principles of the invention.

FIG. 3A illustrates one embodiment of a process for activating the program status bar feature in accordance with the principles of the invention.

FIG. 3B illustrates one embodiment of a process 340 for displaying the status bar in accordance with the principles of the invention.

FIG. 4 illustrates one embodiment of the status bar superimposed over a program displayed on a display screen.

FIG. 5 illustrates a detailed block diagram of one embodiment of the IRD 110 of FIG. 1A.

FIG. 6 illustrates a detailed block diagram of one embodiment of the Main Logic Block 410 of FIG. 4.

### DETAILED DESCRIPTION OF THE PREFERRED EMBODIMENTS

Herein, various terms are used to describe certain elements or characteristics of the present invention. For example, a “communication link” is broadly defined as any communication path between a source and a destination. The communication line may include one or more information-carrying lines (electrical wire, fiber optics, cable, etc.) or wireless communications through established techniques such as infrared (IR) and radio frequency (RF) signaling. A “signal” is construed as information transmitted in a parallel or serial manner. Stored within the system, “programming data” includes information of channels chosen by the user to be entered into memory. While certain illustrative embodiments are described in order to convey the spirit and scope of the present invention, such embodiments should not be construed as a limitation on the scope of the present invention.

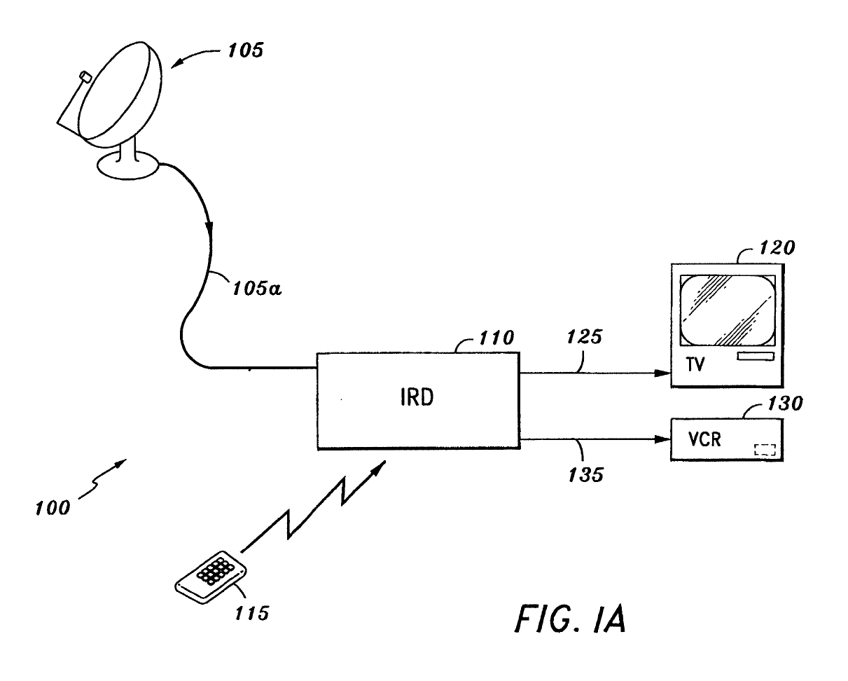

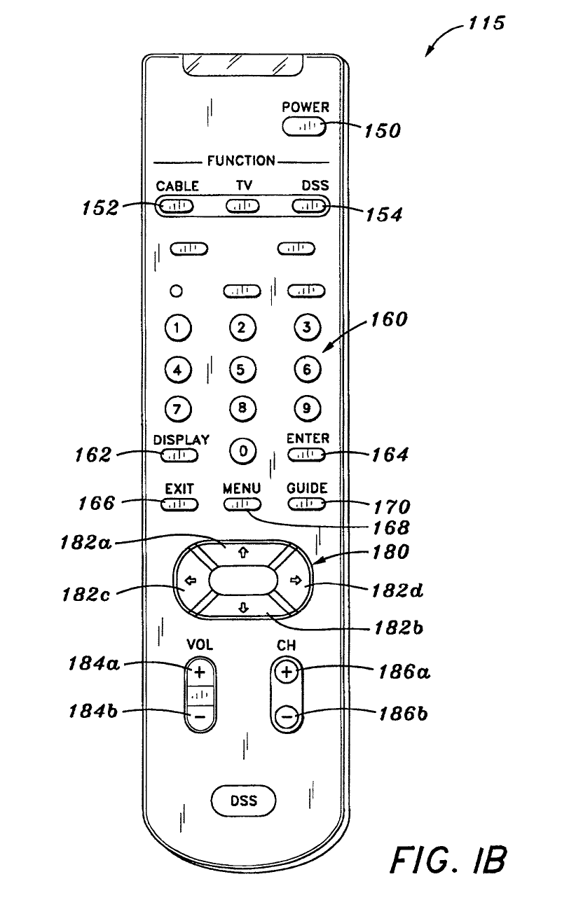

Referring to FIG. 1, one embodiment of an entertainment system utilizing the present invention is shown. The entertainment system 100 comprises an antenna 105, a broadcast receiver 110 such as an integrated receiver decoder (IRD) for example, and at least one analog-input peripheral device (e.g., a display monitor such as television receiver “TV” 120 and/or an analog recording device 130 such as a video cassette recorder “VCR”). The broadcast receiver, in general, receives a broadcast signal (a digital bit stream for example) and performs operations on the broadcast signal to produce digital and/or analog information. Although the IRD is implemented as the broadcast receiver in this embodiment, other types of broadcast receivers may be used such as a cable box for a Cable Broadcasting System, an Internet terminal, a digital satellite system (DSS) computer and the like.

Antenna 105 receives the digital bit stream from an orbiting satellite (not shown) and routes the bit stream to IRD 110. The bit stream is formatted in accordance with any video compression function and is usually encrypted under either a symmetric key cryptographic function or a public-key cryptographic function. Typically, the bit stream includes sensory data (e.g., video and/or audio, or communication data) and control information for a number of shows. The control information for each show includes programming data having the following content: date of broadcast, broadcast channel number, show start-time, show end-time, and also show title.

IRD 110 is responsible for decoding the bit stream, for storing programming data in timer memory accessible by software executed by IRD 110, and for processing the decoded bit stream to produce one or more output signals having appropriate formats. As shown, an output signal is placed in an analog format and sent via communication line 125 to TV 120 for viewing, and/or via communication line 135 to analog recording device 130 for recording. The analog format may be in accordance with a video format established by National Television Systems Committee (NTSC), or perhaps other video formats, including but is not limited or restricted to Phase Alternating Line (PAL), Sequential Couleur Avec Memoire (SECAM) and other recognized formats.

Additionally, IRD 110 is responsible for responding to a plurality of commands from a remote control 115. Remote control 115 may include any type of remote control, including one described in U.S. Pat. No. 5,453,758 assigned to Sony Corporation of Tokyo, Japan. FIG. 1B is an illustrative embodiment of the remote control 115 of FIG. 1A. The remote control 115 comprises a power key 150 for activating the IRD 110 via a communication link, a cable key 152 which facilitates selection of cable channels, a DSS key 154 which facilitates selection of satellite-based channels, an OPTIONS key 156 for facilitating selection of desired channels; a LOCK key 158 for facilitating locking and unlocking of the control functions of the remote control 115, a numerical keypad 160, a DISPLAY key 162, an ENTER key 164, an EXIT key 166, a MENU key 168, and a GUIDE key 170. The remote control 115 further comprises an ABXY button grid 180 (which includes scroll buttons 182a-d), a pair of volume keys 184a, 184b, and a pair of channel selection keys 186a, 186b. In one embodiment, the ABXY button grid 180 is a video game control used by many commercially available video systems such as those made and manufactured by Nintendo of Japan.

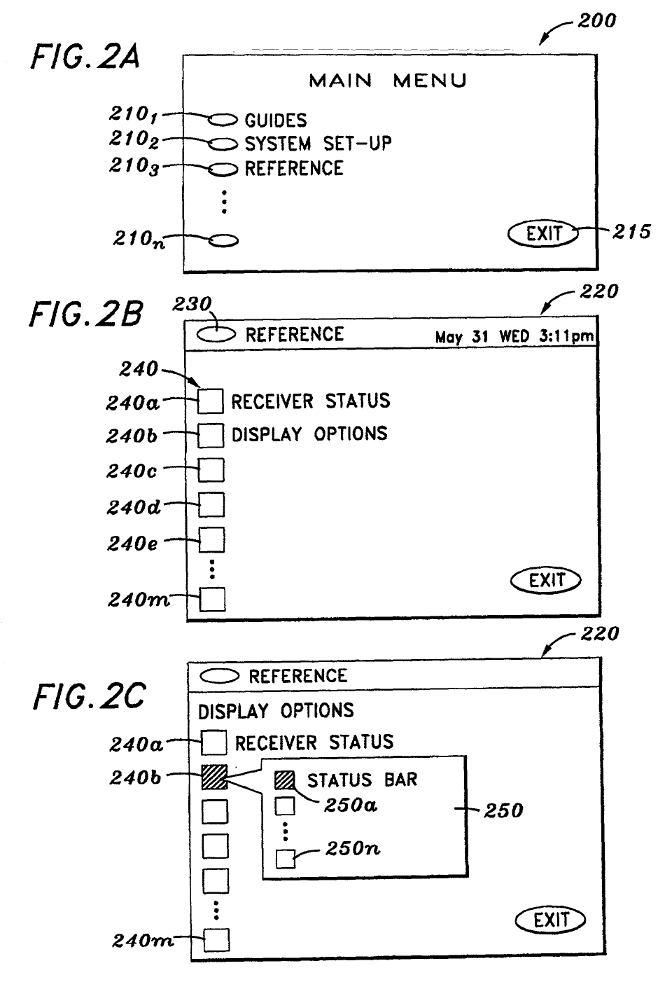

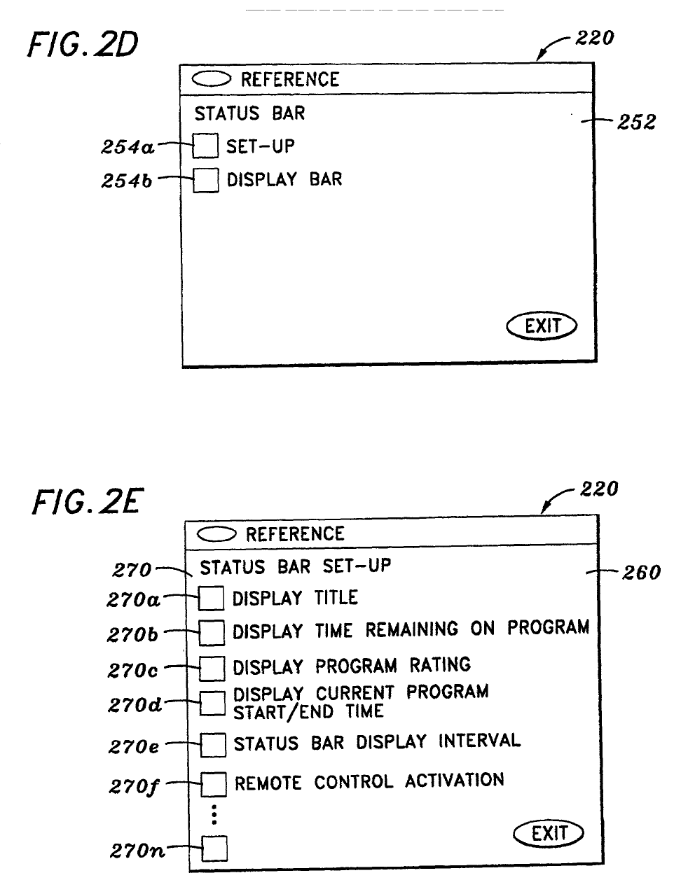

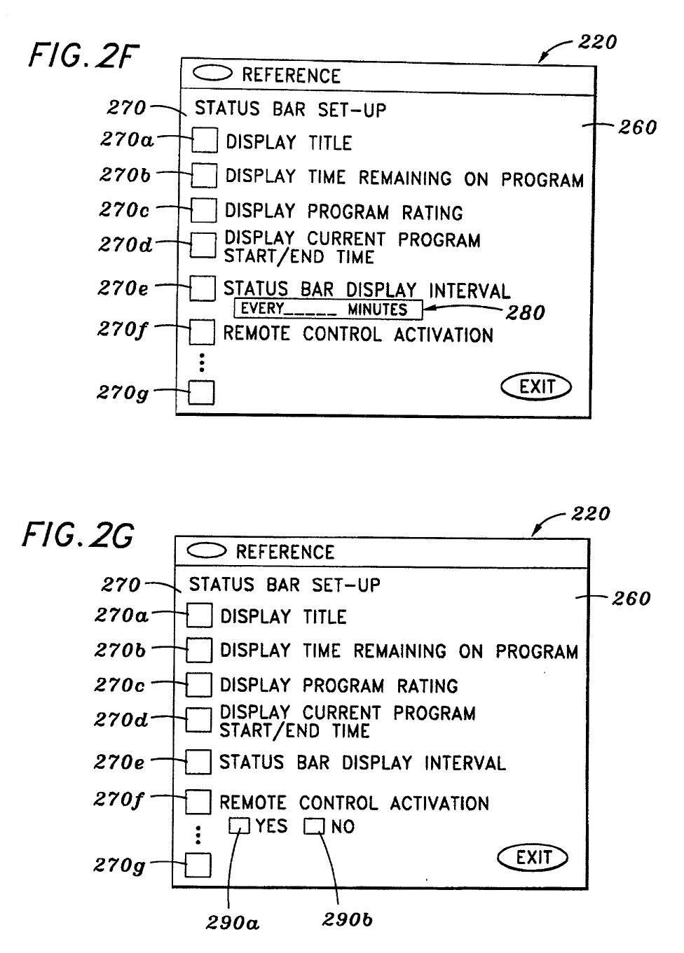

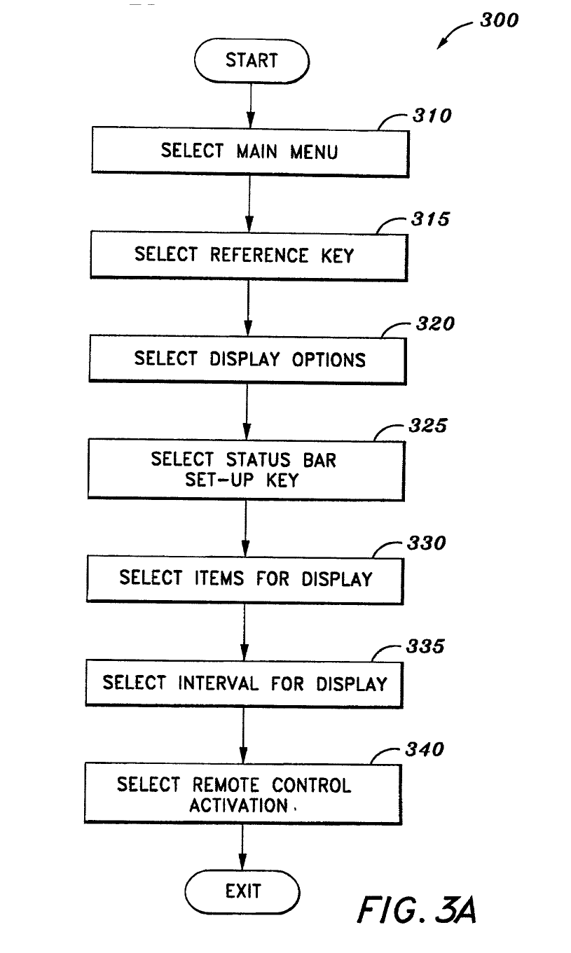

Prior to using the status bar control and display features provided in accordance with the principles of the invention, the remote control 115 has to be set up for such use. To accomplish this, the user may issue a first command from the remote control 115 by pressing the MENU key 168, causing IRD 110 to produce an output signal displaying a main menu 200 on TV 120, as shown in FIG. 2A. The main menu 200 may be superimposed over a view screen (not shown) displaying a show from a selected channel. In one embodiment, the main menu 200 comprises a number of icons 210₁-210ₙ, each of which can be selected to perform a function -associated with the system. In one embodiment, the main menu 210 includes a GUIDES icon 210₃ that the user may select to review additional menus or guide screens, a System Set up icon 210₂, that the user may select to view or adjust the system controls, a Reference icon 210₃, that the user may select to set up viewing of the status of programs. The main menu 210 may also include further icons, which may be selected by using the ABXY button grid 180 (which includes scroll buttons 182a-d), followed by the ENTER key 164. Alternatively, the viewer may scroll through the list using the channel buttons 186a, 186b. To exit from the main menu 200, the viewer may select the EXIT icon 215.

FIG. 2B illustrates one embodiment of the main view screen 220 that is displayed upon selection of the Reference icon 210₃. The Reference view screen 220 includes a banner portion 230 having indicia representative of the view screen that was selected for viewing, which in this case is the Reference, and a body portion 240 that includes a plurality of icons 240a-240m that may be selected to activate or deactivate various functions of the Reference feature. In one embodiment, the icon 240a may be selected to provide the receiver status, and the icon 240b may be selected to view or select various display options. Such selection may be accomplished by using the ABXY button grid 180 (which includes scroll buttons 182a-d), followed by the ENTER key 164.

Upon selection of the display options icon 240b, a window 250 (see FIG. 2C) pops up, to query if the user would like to select viewing of one of a plurality of icons, such as icons 250a-250x. In one embodiment, icon 250a is a Status Bar icon, which when selected, would provide a Status Bar view screen 252, as shown in FIG. 2D. In one embodiment, the Status Bar view screen 252 displays a plurality of icons, such a Set Up icon 254a and a Display Bar icon 254b. Upon selection of the Status Bar Set-Up icon, a Status Bar Set-up view screen 260 is displayed. In on embodiment, the Status Bar Set-Up view screen 260 displays a plurality of icons 270a-n. the icons 270 may include a display Title icon 270a, a Display Time Remaining icon 270b, a Display Program Rating icon 270c, a Display current Program Start/End time icon 270d, a Status Bar display Interval icon 270e, a remote control activation icon 270f, etc. Each of these icons may be selected using the ABXY button grid 180 to scroll down the list, followed by selection using the ENTER key 164. Alternatively, the viewer may scroll through the list using the channel buttons 186a, 186b.

Upon selection of the Status Bar Display Interval icon 270e, a pop-up window 280 appears. In one embodiment, the pop-up window 280 displays the phrase “Display every ______ minutes” and “Duration of display ______” which enables the user to enter the interval and duration of display.

Upon selection of the Remote control Activation icon 270f, a pop-up window 290 appears. The pop-up window 290 includes two icons, a YES icon 290a and a NO icon 290b. If the YES icon 290a is selected, the status bar may be activated using the remote control. Conversely, if the NO icon 290b is selected, the status bar will not be activated using the remote control. Once the Status Bar display features have been set up using the view screens described above, the Status Bar display feature may be used.

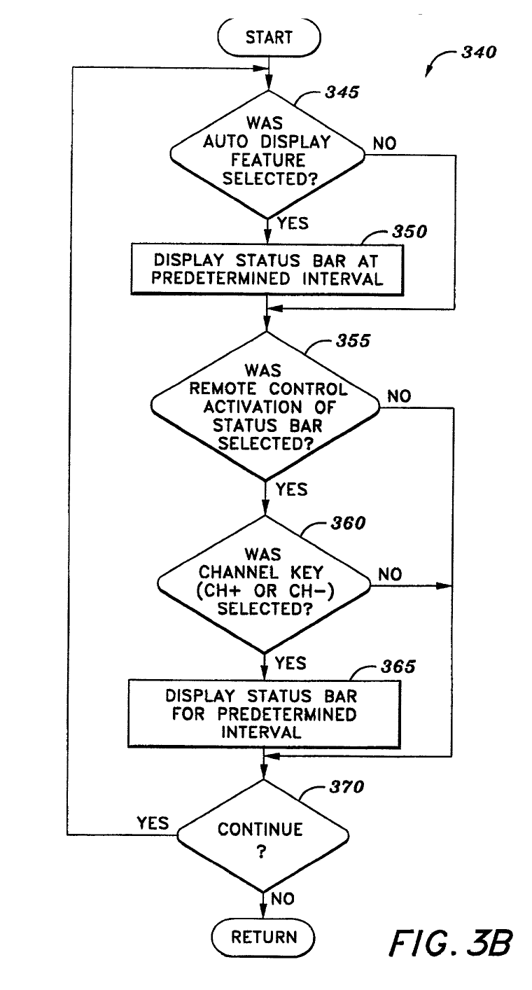

FIG. 3A illustrates one embodiment of a process for activating the program status bar feature in accordance with the principles of the invention. To accomplish this, the viewer may issue a command via remote controller 115 by pressing the MENU key 168 (process block 310), causing IRD 110 to produce an output signal displaying a password menu on TV 120. The user may select the Reference icon 2103 in the main menu (process block 315) to access the Reference menu. Upon displaying the Reference Menu, the user may select the Display Options icon 240b (process block 320). Upon selecting the Display Options icon 240b, a pop-up window 250 appears (FIG. 2C), which enables the user to select a Status Bar icon 250a. Upon selecting this icon 250a, a view screen 252 appears, which facilitates selection of the Status Bar set up feature and display status bar feature (process block 325). Upon selection of the status bar set up icon 254a (FIG. 2D), a plurality of icons 270a-g are displayed, which enable the user to select items to be displayed on the status bar (process block 330), to specify the status bar display interval (process block 335), and to select remote control activation of the status bar (process block 340). For example, the title, display time remaining on the program, program rating, current program start/end time may be selected for display by selecting icons 270a, 270b, 270c and 270d respectively. In addition, the status bar may be displayed at various intervals. For example, when the icon 270e is selected, a pop-up window, such as 280, may be presented, which enables the user to specify that the status bar be displayed every X minutes, where X is an integer (see FIG. 2F). In addition, the display of the status bar may be controlled through the use of a remote control For example, if icon 270f is selected, two additional icons 290a and 290b may be displayed (see FIG. 2G). When icon 290a is selected, it indicates that the status bar may be activated through the use of the remote control 115. When icon 290b is selected, it indicates that the status bar will not be activated through the use of the remote control 115. Upon completion of the status bar set-up process, the status bar display feature is ready for use. The process then terminates or returns to a main process.

FIG. 3B illustrates one embodiment of a process 340 for displaying the status bar in accordance with the principles of the invention. To determine if the status bar should be displayed, the process 340 first queries if the auto display feature of the status bar was selected (process block 345). If so, the status bar is displayed at predetermined intervals, such as every 15 minutes (process block 350). The process 350 then proceeds to decision block 355. If the auto display feature was not selected, the process 340 proceeds directly to decision block 355.

At decision block 355, the process 340 queries if the remote control activation feature of the status bar was selected. If so, the process proceeds to decision block 360, to determine if the either of the channel selection keys CH+ or CH− are depressed. If so, the process proceeds to process block 365, where the status bar is displayed for a predetermined interval. The process 340 then proceeds to process block 370, where it continues monitoring by returning to decision block 345, unless it is terminated. If, at decision block 355, the remote control activation feature was not selected, the process 340 proceeds directly to block 370. In addition, if, at decision block 360, neither of the channel selection keys (CH+ or CH−) were selected, the process proceeds directly to block 370. At decision block 370, the process 340 queries if it should continue. If so, it returns to process block 350. Otherwise, it terminates or returns to a main process.

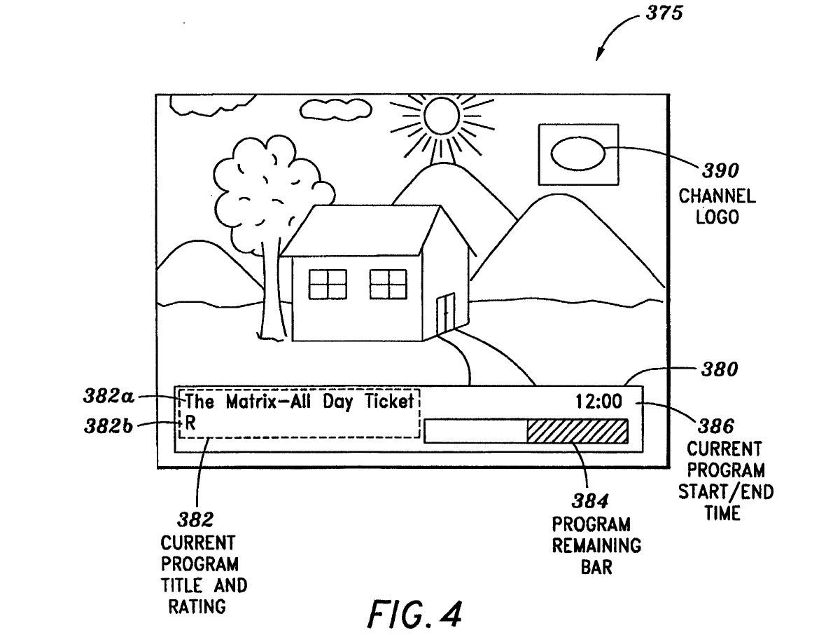

FIG. 4 illustrates one embodiment of the status bar superimposed over a program displayed on a display screen. As shown, the display screen 375 includes a status bar provided in accordance with the principles of the invention. The status bar includes a first section 382, which displays the title 382a of the program currently being displayed. In one embodiment, the first section 382 also includes a rating 382b of the program currently displayed, In another embodiment, the first section further includes a description of the frequency 382c of display of the current program. The status bar 380 may also include a program remaining bar 384 that indicates the time remaining on the program. The status bar 380 may further include a second section 386 that indicates the beginning and/or ending time of the the currently displayed program. In one embodiment, the display screen 375 may include a channel logo 390, which indicates the current channel.

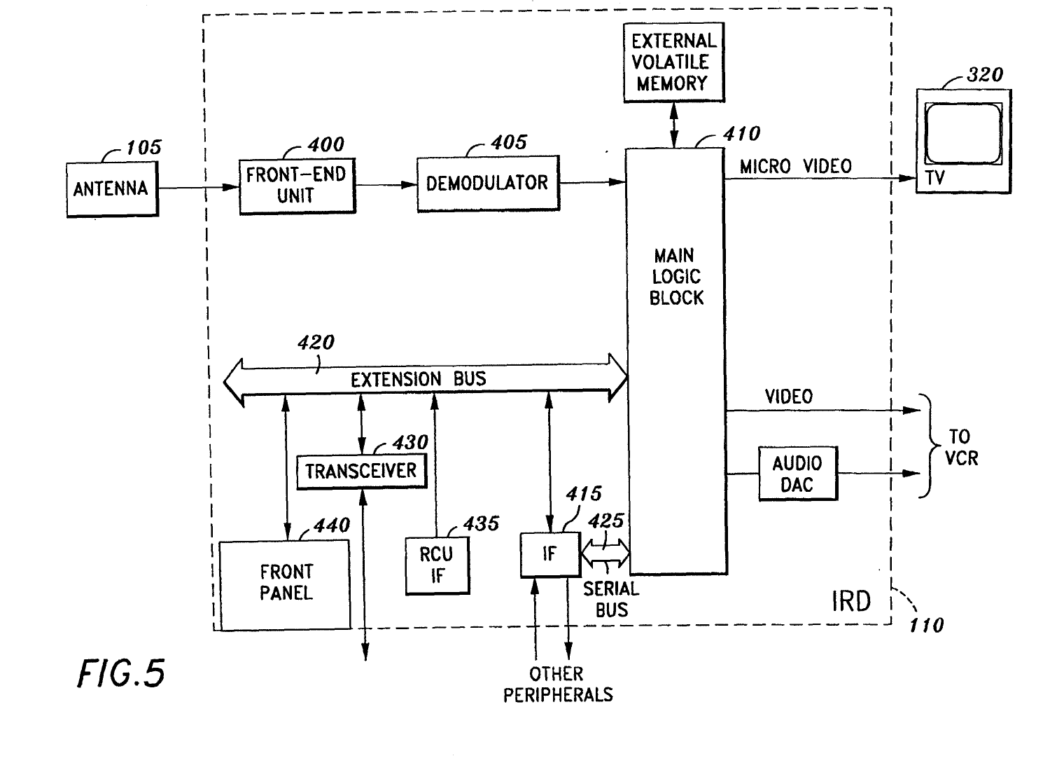

Referring now to FIG. 5, one embodiment of an integrated receiver decoder (IRD) 110 is shown. The antenna 105 transfers the bit stream to a front-end unit 400 of the IRD 110. Although not shown, the front-end unit 400 includes (i) amplification circuitry used to amplify any relatively weak signals received at antenna 105, and (ii) a tuner which allows a user to receive a desired broadcast channel.

For the case where the user wishes to view a show provided by the digital satellite system service provider, the bit stream associated with the desired broadcast channel is routed from front-end unit 400 to a demodulator 405. In demodulator 405, the bit stream is initially processed before transferring to a main logic block 410 for further processing. Such initial processing may include exposing the bit stream to QPSK-demodulation, viterbi-decoding, de-interleaving and Reed-Solomon decoding.

In certain situations, IRD 110 is connected to other peripheral devices though an interface (IF) 415. In this embodiment, IF 415 may include a link layer integrated circuit (IC) and a physical layer IC (not shown) and complies with the IEEE standards document 1394 entitled “Standard for High Performance Serial Bus” (hereinafter referred to as “IEEE 1394”). This enables IRD 110 to connect to digital-input peripheral devices such as digital VCRs, digital video disk players, digital laser disk players and the like. These digital-input peripheral devices communicate with a central processing unit (CPU) within main logic block 410 (see FIG. 5) through IF 415 and either extension bus 420 or alternatively an IEEE 1394 serial bus 425.

Referring still to FIG. 5, extension bus 420 supports input/output (I/O) communications by providing a communication path between electronic circuitry of the main logic block 410 and a number I/O related devices. These I/O related devices include a transceiver device 430 (e.g., a modem), a remote command unit interface (RCU-IF) 435, and a front panel 440. In one embodiment, the front panel 440 includes buttons or switches for receiving user input or commands. The buttons or switches may correspond to those on the remote controller 115 and the buttons or switches on the front panel 440 may be used to issue commands to the IRD 110 instead of the remote controller 115. RCU-IF 435 receives commands from the remote controller 115, and decodes the commands to produce interrupt request signals (IRQs) corresponding to these commands. Each IRQ is transferred to the CPU within the main logic block 410. The front panel 440 includes buttons or switches to provide user functionality and access to the system as described herein. Control of such user functionality and access may also be provided through use of the keys in remote control 115 as described earlier.

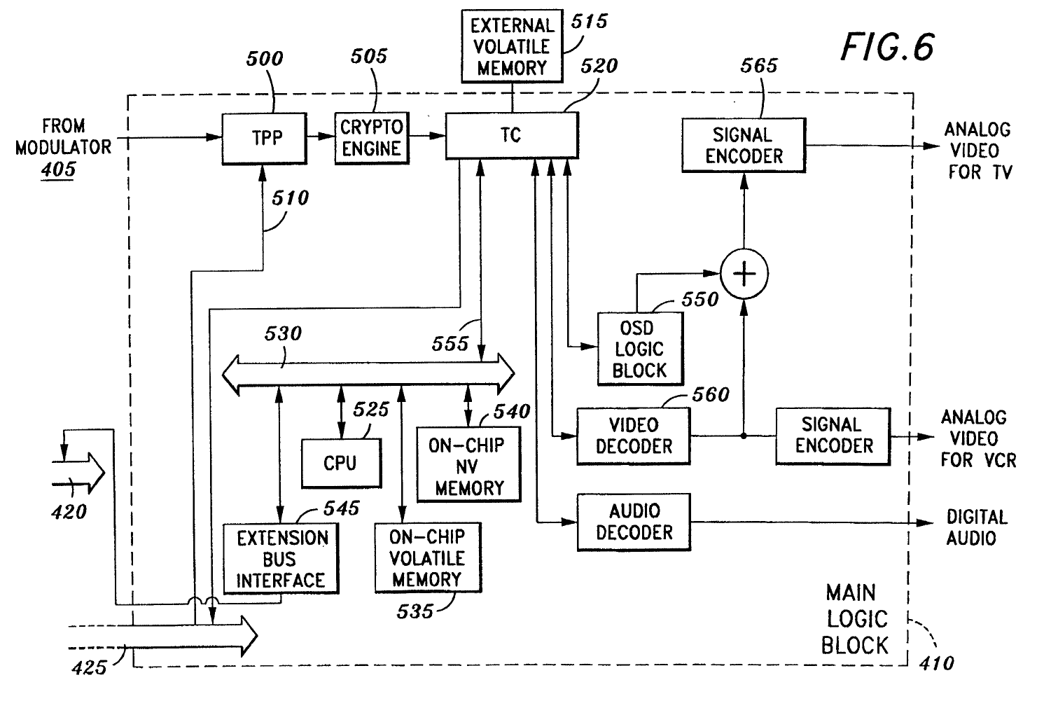

Referring now to FIG. 6, electronic circuitry of the main logic block 410 is shown. The Transport Packet Parser (TPP) 500 receives the decoded bit stream and parses the bit stream. This parsed bit stream is decrypted by a cryptographic engine 505 which may operate in accordance with a cryptographic function, for example Data Encryption Standard (DES). However, if the bit stream is received from IF 415 via communication line 510, cryptographic engine 505 will be precluded from decrypting the bit stream since it is already in a decrypted form. Thereafter, the decrypted bit stream, including the programming data, is stored in an external volatile memory 515 (e.g., random access memory “RAM”) under the control of traffic controller (TC) 520.

CPU 525 controls the operations of the IRD by communicating with a plurality of elements through an internal high-speed bus 530. These elements include an optional volatile memory 535, at least one non-volatile (NV) memory element 540 (e.g., read only memory “ROM”, erasable programmable read only memory “EPROM”, flash memory, etc.) to contain software programs, extension bus interface 545, and traffic controller 520. NV memory element 540, in lieu of external NV memory 445 of FIG. 5, may be used to store software needed by CPU 525 (e.g., interrupt software) or perhaps stored channel data. Extension bus interface 545 allows CPU 525 to communicate with the devices coupled to extension bus 420.

Referring to FIGS. 5-6, the operations performed by IRD 110 to support status bar control and display functions are described. Upon receiving the first command from the remote control (e.g., user depressing “MENU” button 170 of remote control), RCU-IF 435 transfers a first interrupt request signal (IRQ1), corresponding to the first command, directly to CPU 525 or indirectly through a queuing mechanism (not shown). In response to detecting IRQ1, CPU 525 executes interrupt software contained in external NV memory element 445 (or NV memory element 540) and services IRQ1.

More specifically, in order to service IRQ1, CPU 525 executes interrupt software, normally coded to control an on-screen display (OSD) logic block 550, to produce the main menu 200 (see FIG. 2A). The user may then use the ABXY grid or the channel buttons 186a, 186b to scroll through the icons 2101-210n. Selection of any one of the icons may be accomplished by pressing the ENTER key 164. Upon selecting the REFERENCE icon 210₃, the REFERENCE view screen 220 is displayed. The user may scroll through the icons 240a-m using the ABXY grid or the channel buttons 186a, 186b. To select the display options for the status bar, the user may scroll to icon 240b and press the ENTER key 164 (see FIG. 2B). In response, a prompt window 250 appears, providing various options including the option for controlling the Status Bar. By selecting this option, a Status Bar view screen 252 appears (see FIG. 2D) which enables the user to enter selections in controlling and displaying the status bar (see FIG. 2D). If the user selects the SET-Up icon 254a icon 255a in the Status Bar view screen 252, a number of icons 270a-g will be displayed, enabling the viewing to select various options for controlling and displaying the status bar. If the Display Bar icon 254b is selected, the Status Bar feature will be implemented and displayed.

The user can now user the status bar display feature. To do so, he has to press the CH+ or CH− key 186a or 186b on the remote control 115. Upon receiving this command from the remote control, RCU-IF 435 transfers a second interrupt request signal (IRQ2), corresponding to the second command, directly to CPU 525 or indirectly through a queuing mechanism (not shown). In response to detecting IRQ2, CPU 525 executes interrupt software contained in external NV memory element 445 (or NV memory element 540) and services IRQ2. In one embodiment, the CPU 525 signals OSD logic block 550 to display the status bar.

The main menu 200, REFERENCE menu 220, and/or the status bar may be superimposed over video by mixing the main menu 200, REFERENCE menu 220 and/or the status bar with video output from video decoder 560. The video output is video received by main logic block 410 and decompressed in accordance with Moving Picture Experts Group (MPEG), Joint Picture Experts Group JPEG) or any other video decompression function. The resulting mixed video output is transferred to signal encoder 565. Signal encoder 565 converts the mixed video output into an analog signal having a recognized video format such as NTSC, PAL, SECAM and the like.

It is contemplated that the invention may be implemented for use in display systems other than that provided using an IRD 110. For example, the invention may be implemented in a television system, an in-flight entertainment system, or a computer network system or any other electronic system. It may be used to quickly and conveniently store a list of channels for the viewer to subsequently view and/or select from.

Through the implementation of the present invention, a program status bar may be provided to facilitate display of details related to a currently display program.

The present invention described herein may be designed in many different embodiments and using many different configurations. As discussed herein, the architecture of the IRD is flexible. While the present invention has been described in terms of various embodiments, other embodiments may come to mind to those skilled in the art without departing from the spirit and scope of the present invention. The invention should, therefore, be measured in terms of the claims which follow.

What is claimed is:

1. A method for displaying information on a display device in an entertainment system, comprising:
selecting a key corresponding to a broadcast channel;
displaying a show associated with the channel;
simultaneously displaying a status of the show for a predetermined period of time.

2. The method of claim 1, wherein the status of the show comprises a time remaining for broadcasting the show.

3. The method of claim 1, wherein the status of the show comprises a start time of the show.

4. The method of claim 1, wherein the status of the show comprises an end time of the show.

5. The method of claim 1, wherein the status of the show comprises a title of the show.

6. The method of claim 1, wherein the status of the show comprises a rating of the show.

7. The method of claim 1, further comprising configuring the entertainment system to display the status of the show.

8. The method of claim 7, wherein configuring the entertainment system comprises:
selecting display items corresponding to the status of the show;
selecting a duration of the predetermined period of time.

9. The method of claim 8, further configuring the entertainment system further comprises selecting display of the status of the show through the use of an input device.

10. The method of claim 1, further comprising displaying the status of the show at a predetermined interval during display of the show.

11. An entertainment system comprising:
a display monitor; and
a broadcast receiver coupled to the display monitor, the broadcast receiver including
a front-end unit capable of receiving programming data associated with a show broadcast for viewing on the display monitor,
a memory, and
a central processing unit coupled to the memory, the central processing unit to execute software to display a show associated with a broadcast channel in response to selection of a key corresponding to the broadcast channel, said central processing unit to execute software to simultaneously displaying a status of the show for a predetermined period of time.

12. The entertainment system of claim 1 1, wherein the status of the show comprises a time remaining for broadcasting the show.

13. The entertainment system of claim 11, wherein the status of the show comprises a start time of the show.

14. The entertainment system of claim 11, wherein the status of the show comprises an end time of the show.

15. The entertainment system of claim 11, wherein the status of the show comprises a title o f the show.

16. The entertainment system of claim 11, wherein the status of the show comprises a rating of the show.

17. The entertainment system of claim 11, wherein the central processing unit further executes software to configure the entertainment system to display the status of the show.

18. The entertainment system of claim 17, wherein configuring the entertainment system to display the status of the show comprises requesting selection of display items corresponding to the status of the show, requesting selection of a duration of the predetermined period of time, receiving input corresponding to the selection of the display items and the selection of the predetermined period of time.

19. The entertainment system of claim 18, wherein configuring the entertainment system further comprises requesting selection of the status of the show through the use of an input device, and receiving input corresponding to the selection of the status of the show through the use of an input device.

20. The entertainment system of claim 19, wherein the central processing unit further executes software to display the status of the show at a predetermined interval during display of the show.
